(19) United States
(12) Patent Application Publication
(10) Pub. No.: US 2005/0091310 A1
(43) Pub. Date: Apr. 28, 2005

(54) Method and system for hosting a plurality of dedicated servers

(75) Inventor: Raphael Salomon, Tel Aviv (IL)

Correspondence Address: FOGG AND ASSOCIATES, LLC, P.O. BOX 581339, MINNEAPOLIS, MN, 55458-1339, US

(73) Assignee: Sphera Corporation, Newton, MA (US)

(21) Appl. No.: 10/888,036

(22) Filed: Jul. 9, 2004

Related U.S. Application Data
(63) Continuation-in-part of application No. PCT/IL03/00003, filed on Jan. 2, 2003.

(30) Foreign Application Priority Data
Jan. 10, 2002 (IL) 147560

(51) Int. Cl. G06F 15/16

(52) U.S. Cl. 709/203; 709/249; 709/228

(57) ABSTRACT

A method and system for hosting one or more virtual dedicated servers on a hosting computer system is disclosed, such that accessing the system utilities and application programs is carried out remotely via a data network. After creating each virtual dedicated server by assigning a sub directory tree derived from the root directory of the hosting computer file system as its root directory tree, placing operating system utilities, program(s) to be executed by the virtual dedicated server and/or hard links to the program(s) on the sub directory tree, data incoming through the communication port(s) of the computer system is intercepted. Upon identifying a request for service, the data is processed so that the virtual dedicated server to which the request is directed can be identified and the request is forwarded to the service provider.

### CROSS-REFERENCE TO RELATED APPLICATIONS

This application is a continuation-in-part of PCT International Application No. PCT/IL2003/000003, filed 02 Jan. 2003 and titled “A METHOD AND SYSTEM FOR HOSTING A PLURALITY OF DEDICATED SERVERS”, which claims benefit under 35 U.S.C. §119(a) of Israeli Application Serial No. 147560, filed 10 Jan. 2002.

### FIELD OF THE INVENTION

The present invention relates to the field of dedicated servers. More particularly, the present invention relates to a method and system for hosting a plurality of dedicated servers on a single computer system.

### BACKGROUND OF THE INVENTION

In the prior art, there have been no readily available off-the-shelf solutions catering to the particular needs of Web-Hosting Providers (WHP). “WHPs” had to develop their own software in-house to automate routine, time-consuming daily tasks. These systems have many flaws that prevent them from driving the deployment of new service offerings. Despite being created by service providers, whose main focus is on the provision of various types of services, these point solutions have taken a “bottoms-up” approach to management, where the administrator must understand the low-level server details in order to configure a customer's service. For example, an administrator must manually allocate an IP address, perform DNS registration and set-up on the local servers, and add user accounts to the new server, before proceeding with the provisioning process. Hence, a related drawback of existing management systems is the fact that many skilled, highly paid, difficult to find and retain engineering resources are required to perform many of the complex and repetitive operations in provisioning hosted services.

On one hand, it is preferable for an enterprise to manage all the facilities of its Web site by its staff. On the other hand, maintaining a Web site is too expensive. Consequently, a reasonable solution is outsourcing the Web services of a WHP. Hosting a website locally is also expensive, as it requires allocating sufficient bandwidth for Internet traffic to the site, as well as allocating resources for keeping the site available all the time (both in terms of software and hardware) and handling security aspects, such as a firewall.

WHPs use a variety of service models to address different types of customers, depending on their required class of service. The Web sites of small and medium-sized businesses normally do not preempt the resources afforded by a dedicated server, and are therefore better served by the shared server model. However, as their requirements change and their sites conduct more and more activity, they become more resource-consuming and need a convenient upgrade path to scale up their operations towards managed dedicated hosting.

In the prior art, the term Virtual hosting refers to maintaining a plurality of Web domains on a single computer system.

There are two methods for carrying out virtual hosting: Name-based and IP-based. In IP-based virtual hosting, one host computer deals with a plurality of IP addresses, each of which corresponds to a domain. In name-based virtual hosting, one IP address is shared between a plurality of domains.

The HTTP/1.1 protocol and a common extension to HTTP/1.0 support name-based virtual hosting, and accordingly, Web servers correspond to this protocol. However, in the prior art, no solutions to the problem of sharing one IP address between a plurality of domains that provides FTP and e-mail services has been presented.

The only solution in the prior art is creating a plurality of virtual computers (referred herein as to Virtual Dedicated Server—VDS), by executing a plurality of duplicates of the Unix-based (or similar) operating system. On one hand, this solution is general, since each vitrual computer supports the whole operating system. However, this benefit is also a drawback, since it consumes a substantial portion of the computer resources. For example, a typical Unix-based system that comprises a Pentium 800 processor and 256 MB physical memory can host up to 10 duplicates of a Unix-based operating system.

Another drawback is that the hosting computer resources are divided in a static manner between the virtual computers. The result is that if, for example, the real computer is split up into 10 identical virtual computers, then 10% of the system resources are allocated to each virtual computer, even if only one virtual computer is being executed. A dynamic resource allocation would result in a better performance per virtual computer and therefore a better performance form the user point of view.

An emulation of a computer system in which a remote client can access its system utilities and programs is referred herein to as a Virtual Dedicated Server (VDS). A plurality of VDS instances can be executed simultaneously on one hosting computer system.

It is an object of the present invention to provide a method and system for hosting a plurality of virtual dedicated servers, on which more VDSes can be executed on the computer, in comparison to the prior art.

It is another object of the present invention to provide a method and system for hosting a plurality of virtual dedicated servers, on which accessing the files system of one VDS from another VDS is prevented.

It is a further object of the present invention to provide a method and system for hosting a plurality of virtual dedicated servers, on which the performance of the hosted VDSes is improved in comparison to the prior art.

It is a still further object of the present invention to provide a method and system for hosting a plurality of virtual dedicated servers, in which the consumption of the computer resources (such as CPU, resident memory and disk storage) is reduced in comparison to the prior art.

It is yet another object of the present invention to provide a method and system for hosting a plurality of virtual dedicated servers, which enables operation of multiple virtual dedicated servers on a single instance of the operating system, wherein the separation between the servers is obtained by utilizing mechanisms of the operating system.

Other objects and advantages of the invention will become apparent as the description proceeds.

### SUMMARY OF THE INVENTION

In one aspect, the present invention is directed to a method for hosting one or more virtual dedicated servers on a hosting computer system, operating with a single instance of the operating system, each of which being an emulation of the hosting computer system on which accessing the system utilities and application programs is carried out remotely via a data network, comprising:
Creating each virtual dedicated server, by:
Assigning a sub directory tree, derived from the root directory of the hosting computer file system, as the root directory tree of the virtual dedicated server;
Placing a subset of the operating system utilities on the sub directory tree of the virtual dedicated server, as required by the services to be provided by the virtual dedicated server and by the operating system of the hosting computer in order to operate essentially in its regular operation mode;
Placing program(s) to be executed by the virtual dedicated server and/or hard links to the program(s) on the sub directory tree;
Intercepting data incoming through the communication port(s) of the computer system;
Upon identifying in the data a request for service from a service provider associated with one of the virtual dedicated servers:
Identifying the virtual dedicated server to which the request is directed by processing the data;
If the provider of the service is not invoked yet on the virtual dedicated server, invoking the provider of the service stored in the corresponding sub directory tree of the virtual dedicated server;
Forwarding the request to the service provider and provisioning the service by the service provider;
Optionally, upon terminating the provisioning of a request for service, terminating the process of the service provider.

Optionally, some or all of the operating system utilities may be replaced by corresponding hard links.

Optionally, the sub directory tree is restricted by an account of the hosting computer.

One or more of the virtual dedicated servers may be identified by their unique IP address, while other may be identified by one shared IP address and their name.

Optionally, the invention may be implemented on a Unix-based system.

When implementing the invention on a Unix-based system, a process being executed on a virtual dedicated server can be restricted to its sub directory tree by the means of the Chroot system call or equivalent.

In order to achieve better security, a setuid system call (or equivalent) should be used, to grant the process only the permissions of the relevant user. Using “setuid” would achieve several purposes:

The process shall not run as root, thus will not be able to get out of its limited sub-tree by “chroot” to another directory.

The process shall not be able to access restricted system resources.

The process shall not be able to access information (files and processes) of other VDSes—based on the permissions system of the operating system. Only users with the relevant user ID can access them.

System manager can easily locate and manage processes of a specific VDS—by filtering according to the user ID of the processes.

Some or all of the VDSes hosted by a hosting computer system can be administrated by one Sysadmin.

When implementing in a Unix-based system, no change of the kernel of the system is required.

According to one embodiment of the invention, the operating system calls regarding the utilization of the hosting computer's resources are intercepted for monitoring the computer's resources consumption. Optionally, the monitoring is used for obtaining the utilization rate of the virtual dedicated server(s), and/or for providing at least a predefined service level to the virtual dedicated servers, and/or for providing a minimum of Quality of Service to the virtual dedicated servers.

The service provider may be an operating system service, or a program being executed on the virtual dedicated server.

The data network may use TCP/IP, or any other protocol.

In another aspect, the invention is directed to a computer system for hosting one or more virtual dedicated servers, each of which being an emulation of the computer system on which accessing the system utilities and application programs is carried out remotely via a data network, for each virtual dedicated server comprises:
A sub directory tree derived from the root directory of the computer's file system as the root directory tree of the virtual dedicated server;
A subset of the operating system utilities on the sub directory tree of the virtual dedicated server, as required by the services to be provided by the virtual dedicated server, according to the required by the operating system of the hosting computer in order to operate essentially in its regular operation mode;
Software means for intercepting data passing through the ports and for directing the data to the appropriate virtual dedicated server;
Software means for analyzing the data and for identifying the virtual dedicated server to which the data is to be directed and for forwarding the data to the virtual dedicated server.

Preferably, the computer system is operating with a single instance of the operating system, and/or the file system and operating system services are shared by the VDSes. The sub directory tree may be restricted by an account of the hosting computer. Optionally, one or more of the virtual dedicated servers are identified by their unique IP address, or alternatively, by one shared IP address and their name. Furthermore, some or all of the operating system utilities can be replaced by corresponding hard links.

A process may be restricted to its sub directory tree in a Unix-based operating system by the means of the Chroot system call or equivalent, or by the means of the Setuid system directive or equivalent.

The computer system may be implemented in a Unix-based system without requiring modification of the kernel. Additionally, the operating system calls regarding the utilization of the hosting computer's resources may be intercepted for monitoring the computer's resources consumption. Such monitoring may be used for obtaining the utilization rate of the virtual dedicated server(s), and/or for providing at least a predefined service level to the virtual dedicated servers, and/or for providing a minimum of Quality of Service to the virtual dedicated servers.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates a file system of a computer for hosting a plurality of VDSes, according to a preferred embodiment of the invention; and

FIG. 2 illustrates an administration diagram, according to a preferred embodiment of the invention.

### DETAILED DESCRIPTION OF PREFERRED EMBODIMENTS

In order to facilitate the reading of the description to follow, a number of terms and acronyms are defined below:

TCP/IP (Transmission Control Protocol/Internet Protocol) is the basic protocol of the internet. TCP controls data transfer, and the IP controls the routing. TCP/IP network is a network in which supports TCP/IP.

A Domain name is the part of the URL (Uniform Resource Locator) that informs a domain name server using the domain name system (DNS) whether and where to forward a request for a Web page or Web service. The domain name is mapped to an IP address, which represents a physical point on the Internet. On one hand, a domain name refers to one IP address. On the other hand, a plurality of domain names can refer to a single IP address.

A Domain refers to a group of Web services provided by, or in behalf of, an enterprise. Usually it comprises a set of network addresses, each of which provides one or more Web services (HTTP, Telnet, FTP, E-mail, etc.), or a set of sub-divisions within the enterprise, such as finance, R&D, and so forth.

Client/server describes the relationship between two computer programs in which one program, the client, makes a service request from another program, the server, which fulfills the request. Although the client/server idea can be used by programs within a single computer, it is a more important idea in a network. In a network, the client/server model provides a convenient way to interconnect programs that are distributed efficiently across different locations. The client/server model has become one of the central ideas of network computing. Most business applications being written today use the client/server model. So does the Internet's main program, such as Web browsers and servers.

Regarding the Web, a Web server is the computer program that serves requested HTML pages or files. A Web client is the requesting program associated with the user. The Web browser in the user's computer is a client that requests HTML files from Web servers (using HTTP protocol).

In the usual client/server model, one server, sometimes called a daemon, is activated and awaits client requests. Typically, multiple client programs share the services of a common server program. Both client programs and server programs are often part of a larger program or application. Relative to the Internet, a user's Web browser is a client program that requests services (the sending of Web pages or files) from a Web server (which technically is called a Hypertext Transport Protocol or Hypertext Transfer Protocol server) in another computer somewhere on the Internet. Similarly, a user's computer with TCP/IP installed allows you to make client requests for files from FTP (File Transfer Protocol) servers in other computers on the Internet.

HTML (Hypertext Markup Language) is the set of markup symbols or codes inserted into a file intended for display on a World Wide Web browser page. The markup tells the Web browser how to display a Web page's words and images for the user. Each individual markup code is referred to as an element (but many people also refer to it as a tag). Some elements come in pairs that indicate when some display effect is to begin and when it is to end.

A CLI (command line interface) is a user interface to a computer's operating system or an application in which the user responds to a visual prompt by typing in a command on a specified line, receives a response back from the system, and then enters another command, and so forth. The MS-DOS Prompt application in a Windows operating system is an example of the provision of a command line interface. Typically, most of today's Unix-based systems offer both a command line interface and a graphical user interface.

A Script is a sequence of CLI commands, usually in order to perform a task. A script might receive parameters for performing the task. For example, the BAT files of Windows and DOS (Disk Operating System) are scripts.

A Web site is a related collection of Web files that includes a beginning file called a home page. From the home page, a Web browser (software used for accessing files on the Internet and displaying the files to a user) can get to all the other pages on the Web site. Actually, the access to the rest of the files can be restricted to some of all the users.

A client process referring to an IP address actually communicates with a Web server. A Web server is a program that using the client/server model “serves” requests for its services. Every computer on the Internet that contains a Web site must have a Web server program. On the one hand, a very large Web site may be spread over a number of servers in different geographic locations. On the other hand, one Web server can host a plurality of Web sites.

Many different servers are in use on the Internet. Some of the more popular ones are: Apache, the Internet Information Server (IIS), and Netscape Enterprise Server. Popular server runs on NT and Unix operating systems.

In the prior art, a Dedicated server refers to the rental and exclusive use of a computer that includes a Web server, related software, and connection to the Internet, housed in a Web hosting company's premises. A dedicated server is usually needed for a Web site (or set of related company sites) that may develop a considerable amount of traffic, such as up to 35 million hits a day. A dedicated server can usually be configured and operated remotely from the client-company. Typically, a dedicated server is rented so that it provides a stated amount of memory, hard disk space, bandwidth, etc.

The term Web services refers herein to services provided by a domain to clients over the Web. For example: HTTP, FTP, and e-mail services.

HTTP (HyperText Transport Protocol) is the communications protocol used to connect to servers on the World Wide Web. Its primary function is to establish a connection with a Web server and transmit HTML pages to the client browser. Addresses of Web sites begin with an “http://” prefix or “https://” for secured HTTP connection.

File Transfer Protocol (FTP) is an Internet protocol for exchanging files between computers on the Internet. Like the Hypertext Transfer Protocol (HTTP), which transfers displayable Web pages and related files, FTP is an application protocol that uses the Internet's TCP/IP protocols.

SMTP (Simple Mail Transfer Protocol) is the standard e-mail protocol on the Internet. It is a TCP/IP protocol that defines the message format and the message transfer agent (MTA), which stores and forwards the mail.

SMTP servers route SMTP messages throughout the Internet to a mail server, such as POP3 or IMAP4, which provides a message store for incoming mail.

POP3 (Post Office Protocol 3) and IMAP (Internet Message Access Protocol) are client/server protocols for connecting a client to a mail server.

Inetd (INternET Daemon) is a Unix process that manages many common TCP/IP services. It is activated at startup, waits for various connection requests (FTP, Telnet, etc.) and launches the appropriate server components. The list of ports and their associated server components (i.e. the processes to be invoked) can be configured.

Operating System is the master control program that runs the computer. The first program loaded when the computer is turned on, its main part, the kernel, resides in memory at all times. Services provided by an operating system to application programs and users are referred herein as System utilities. For example, file services (such as open, close, retrieve, etc.), communication services, task management, etc.

The Kernel is the core that provides basic services for all other parts of the operating system. A synonym is nucleus. A kernel can be contrasted with a shell (the outermost part of an operating system that interacts with user commands).

Typically, a kernel (or any comparable center of an operating system) includes an interrupt handler that handles all requests or completed I/O operations that compete for the kernel's services, a scheduler that determines which programs share the kernel's processing time in what order, and a supervisor that actually gives use of the computer to each process when it is scheduled. A kernel may also include a manager of the operating system's address spaces in memory or storage, sharing these among all components and other users of the kernel's services. A kernel's services are requested by other parts of the operating system or by application through a specified set of program interfaces sometimes known as system calls.

Secure Sockets Layer (SSL) a commonly-used protocol for managing the security of a message transmission on the Internet. SSL uses a program layer located between the Internet's Hypertext Transfer Protocol (HTTP) and Transport Control Protocol (TCP) layers.

Web Hosting

The term Web Hosting refers herein to housing, serving, and maintaining files for one or more Web sites.

Typically, Web hosting provides the following services:
File storage for storing the Web files accessible by a Web server (HTTP services);
e-mail addresses and e-mail services;
FTP;
Maintaining the computer for the domain owner, including maintaining user accounts, installing new software and software updates needed by the Web site for its operation.

The services are provided through an IP address that corresponds to the domain name of the enterprise that owns the domain.

An enterprise can host its domain and manage its own Web hosting requirements by maintaining its own Web server(s). Another alternative is using the service(s) of an ISP (Internet service provider). In both cases, skilled personnel should be involved, usually referred to as the system administrator or Sysadmin.

When the Web requirements of an enterprise grow beyond a certain point (for example, due to adding new services to its Web site or growth in the amount of traffic on its Web site), the enterprise may use a dedicated server. However, this solution has major drawbacks, particularly the limited ability of the dedicated server to provide services beyond HTTP services, which results in dependency of the enterprise on the Internet service provider in the maintenance of the dedicated server (e.g., adding new e-mail accounts).

From the ISP side, there is an interest in sharing the same computer system between as many clients as possible. In this way, the expenses of maintaining the computer system can be shared between several clients (companies), and the ISP will be able to reduce the prices of his dedicated servers and still remain profitable, and hence more attractive to customers.

The Virtual Dedicated Server

According to the invention, these problems and requirements can be solved by the VDS concept.

Virtual Dedicated Server (VDS) refers herein to an emulation of a computer system dedicated mainly for Web hosting, in which an operator can access the system utilities and programs of the emulated computer remotely via a data network. A plurality of VDS instances can be executed simultaneously on one hosting computer system.

All the VDSs share the same instance of the operating system, and the separation between the servers is by utilizing mechanisms of the operating system.

Typically, a VDS should be able to host Internet servers (such as Web servers, FTP servers, E-mail servers), application programs (such as accounting), e-commerce applications, etc.

A VDS should provide services such as:

Hosting Web sites.

Virtual e-mail servers, so that each virtual e-mail server has its own users. For example, if domains aaa.com and bbb.com are hosted by the same computer, the users “myname@aaa.com” and “myname@bbb.com” are not the same user, and the creation of such users is possible.

Virtual FTP server—which is similar to the e-mail issue.

Telnet access to the operating system utilities. Using Telnet, a domain owner (or his Sysadmin) can perform all the operations that can be carried out if the host computer was totally his, such as browsing files, executing scripts, adding and deleting users, etc.

Prior Art

The concept of using a single computer system for hosting a plurality of virtual dedicated servers has already been dealt with in the prior art. The solution to this issue introduced in the prior art comprises using an instance of the operating system for each dedicated server. On one hand, this solution is general, and hence suitable for numerous applications. On the other hand, not all the resources of the operating system and the computer are required for Web hosting, and hence there is a waste of the resources of the hosting computer system.

The Problems of Implementing VDS

Emulating a plurality of virtual dedicated servers on one computer system causes several problems: on the management level, at the execution level, and at the security level. Adding a new Web site requires a complicated procedure. Maintaining a Web site also is a complicated process. From the security point of view, the fact that the owner of a domain/Web site has access to the storage media of the hosting computer is an opening for accessing and damaging the content of other Web sites hosted by said Web server.

The File System of a VDS

Without any loss of generality, the examples herein refer to a Unix-based operating system, such as Linux and Solaris, or “Unix-oriented” operating systems such as AIX, Irix, Tru64, HP/UX.

All of the files in the Unix file system are organized into a multi-leveled hierarchy called a directory tree. At the very top of the file system is a single directory called root, which is represented by a / (slash). All other files are “descendants” of the root.

Another element concerning this issue is the account. Before a user can begin to use the Unix system, he needs to have a valid username and a password. Assignment of usernames and initial passwords is typically handled by the System Administrator or a “Computer Accounts” office. The username, also called a UserId, must be unique and should not change.

A file and directory in the file system can be protected from or made accessible to other users by changing its access permissions. A user has the responsibility for controlling access to their files. Permissions for a file or directory may be any or all of: r—reading; w—writing; x—executing a program. Permission can be controlled at three levels: u—user; g—group; o—other (everyone on the system). Some Unix versions also allow setting permissions at a specific user level, but it is not part of the standard Unix.

A program executed by the Unix operating system is called process. Since Unix is a multi-tasking operating system, any user can have multiple processes running simultaneously, including multiple log-in sessions. Within the log-in shell, each command creates at least one new process while it executes.

Access permission is a set of permissions associated with every file and directory that determine who is entitled to read, write, or execute it. Only the owner of the file (or the super-user) can change these permissions, unless the access permission was set to enable the writing and executing.

A Super-user account is a privileged account with unrestricted access to all files and commands. Many administrative tasks can only be performed by a super-user account. Some Unix variants split this ability between several accounts such that each one is privileged only on some aspects of the operating system.

According to one embodiment of the invention, the VDS is provided with its own account (or group of accounts) and directory tree. Moreover, in order to gain security for a VDS, the directory-tree of a VDS should be restricted for the use of this VDS only. In this way, a user of one VDS will not be able to access the directory tree of another VDS, and consequently hackers will not be able to physically access any directory tree except their own. Of course, the account of a VDS should not be a super-user account.

This approach can be carried out by the Unix Chroot system call, which is a technique under Unix whereby a process is permanently restricted to an isolated subset of the file system. The Chroot system call forces the root directory of the mentioned processes to become something other than its default for the duration of the current process and of any process that it creates. A process under the aegis of a Chroot cannot access the file system above its notion of root directory.

Through the use of the Chroot system call, the root directory of each VDS is redirected to the unique sub-directory dedicated and owned by the VDS. Thus, applications running within the site perceive their disk space to be entirely their own, unaware of any other sites operating on the same computer. In order to achieve the best security, there should not be on VDS directory contained in another VDS directory.

An alternative solution is to rely on the file system permission mechanism, and change the permissions of each VDS files to this user/group only. However, this approach is inferior to the VDS solution, as follows:

The system files are common to all the VDSes, thus each VDS can access (and maybe even modify) files that are not solely his own.

If a VDS user creates a file without paying attention to the right permissions—other VDS users might be able to access it.

The list of the VDSes hosted by a computer system can be obtained from any VDS being hosted on said computer system, and this is not a desired situation.

Once a VDS was added to a computer, the owner of the VDS can operate the VDS as a separate computer, i.e., open new accounts to his VDS, install new software and PowerApps, etc.

A PowerApp is a software module that is installed as a unit on a VDS. A PowerApp is similar to a RPM in Linux, but the mechanism that installs it is tailored to the VDS implementation, and not to the generic operating system. This mechanism is directed to solve several problems, such as automating the installation process and consequently reducing chances of a user to perform a mistake; shortening the installation time; and enabling to perform privileged operations that the user is not allowed according to his regular privileges.

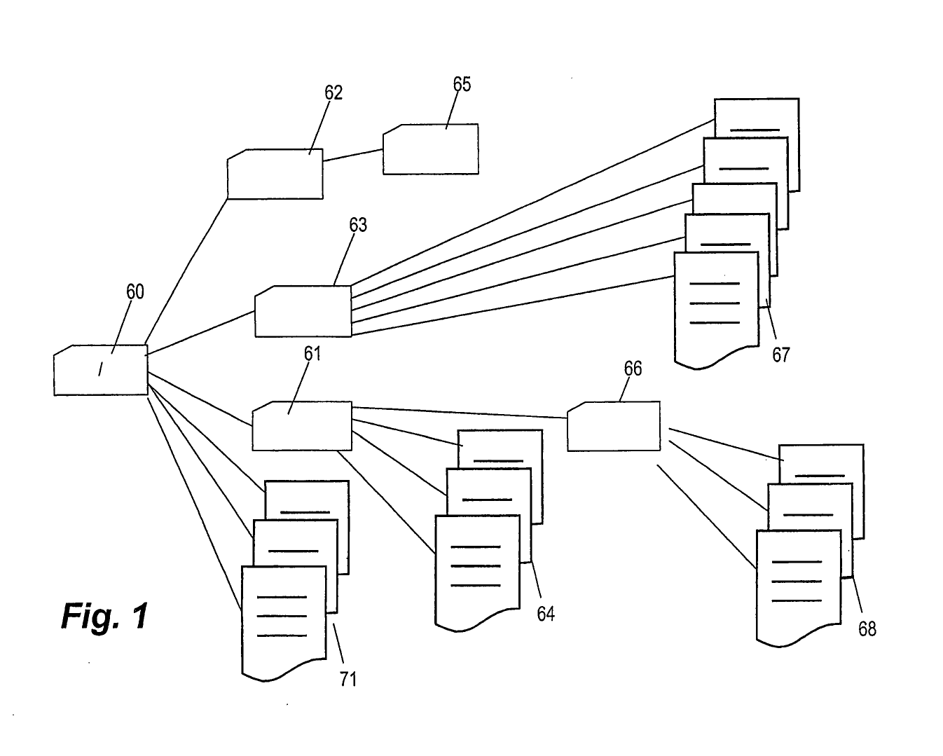

FIG. 1 schematically illustrates a file system of a computer for hosting a plurality of VDSes, according to a preferred embodiment of the invention. The root directory 60 is not owned by any of the VDSes, and it contains the files that are part of the general operating system of the computer. The root directory comprises sub-directories 61 and 62, and a plurality of files 71. Files 71, as well as directory 62 are part of the computer's general file system, and contain files that essential to the working of the OS. The sub-directory 61 comprises a sub-directory 66 and files 64. Each of the sub-directories 61, 63, and 65 can be used as the root directory tree of a process, and since every service of the VDS is performed by a process, each VDS is limited to one sub-directory. It should be noted that if 61 is the root directory of a VDS process, lower levels of the sub-directory tree 61 (i.e. 66) should not be used for VDS, since the VDS that owns sub-directory 61 can access sub-directory 66.

Each directory has its own permissions and restrictions. A VDS associated with one sub-directory is limited to this branch of this sub-directory, i.e., it has no access to the higher level of the directory tree, nor to other branches of the directory tree that are not descendants to his own.

It should be noted that despite of the fact that technically although directories 61 and 65 can be dedicated to a different VDS, it is not recommended since form directory 61 it is possible to access directory 65, and hence the owner of the VDS that its root directory is directory 61 will be able to access the files of the VDS that its root directory is 65.

Improving the Functionality of a VDS by the use of Hard Links

A hard link is essentially a label or name assigned to a file. Conventionally, a file has a single name. However, under Unix it is possible to create a number of different names that refer to the same content of a file. Commands executed upon any of these different names will then operate upon the same file content. Any changes to a file are effective regardless of the name used to refer to the file (the original name or the link name). Hard links cannot span file systems or drives.

In a Unix-based operating system, some files (such as users file/etc/passwd), system commands (such as “/bin/rm”) should be present in specific directories. A VDS, as a “derivative” of the hosting computer, also requires the presence of such files in its sub-directory tree, in the right place that is relevant to its “root”. Although keeping a copy of these files in the sub-directory of a VDS is possible, the use of hard links will be most efficiently, especially in the case when dozens or even hundreds of VDSes are hosted by the computer. This way, a substantial disk space will be saved.

Since there is an appreciable similarity between the VDSes, according to one embodiment of the invention, hard links can be used instead of duplicating some files that are used for each VDS. In this way, the amount of disk space is saved.

The use of hard links also improves the memory consumption of a VDS. Instead of holding in the memory (RAM) an instance of each program that concerns the VDS operation, by the use of hard links only one copy of the program is loaded into the computer's memory, and all the instances of this program refer to this copy. In this way, more memory is available, and hence the amount of swaps of memory chunks between the RAM and the disk media is decreased, and consequently the program execution is faster.

This calculation assumes that the same program is executed by more than one VDS, which is certainly the case of Web hosting, where a few processes (such as Apache) are being executed by each VDS.

Adding a New VDS to the System

According to one embodiment of the invention, installing a new VDS is carried out as follows:
Adding a new user to the operating system with the appropriate permissions;
Creating a sub-directory tree (will be referred herein as the VDS file system) which consists of all the files and directories required for the operation of the VDS. Since there is a similarity between the VDSes, by creating a template directory tree and duplicating it upon adding a new VDS to the system, the procedure is simplified.

Optionally, a subset (or hard links) of the Unix utilities that may concern to the operation of a VDS is added to the VDS file system.

The Sysadmin downloads a Java-applet comprising an interface, preferably a GUI (Graphical User Interface), to his VDS, which provides secure access to his VDS. For example, by encoding/decoding between the user and the VDS, such that one of the keys is the user ID (Usually referred as UID).

Alternatively, the Sysadmin might access the VDS using regular Web browser, by interfacing with HTML pages, preferably over a secured connection using SSL.

As known to the skilled person, there are a variety of methods in the art for holding a secured communication channel between a client and a server.

Typically, this stage is carried out once on each VDS, at the installation stage of the VDS. On a typical Web application, the VDS owner uploads the files of his Web site to the directory tree of the VDS, and when required he can add users to his VDS. This is carried out by the GUI.

The Security Issue

Through the use of the Chroot system call, the root directory of each VDS is redirected to the unique sub-directory dedicated and owned by the VDS. Thus, applications running within a VDS perceive their disk space to be entirely their own, unaware of any other sites operating on the same computer. Additionally, due to the use of the Chroot system calls, an application being executed on one VDS cannot access the file system of another VDS being hosted by the same computer. Thereby, the overall level of the VDS security is improved.

Executing Programs within a VDS

Each program being executed on a VDS should be restricted to the VDS file system and to the account of the VDS. This can be carried out as follows:
Replacing the Internet daemon (Inetd) of the VDS with another daemon which “listens” to the TCP/IP ports. Upon detecting an application for a service associated with the ”listened” ports, the following operations are performed:
Invoking Chroot system call in order to set the VDS file system as the root directory of said process;
Invoking Setuid system call in order to restrict the process to the account of the VDS;
Executing said program (under the restrictions of the directory tree and the account of the VDS on the hosting computer system).

According to one embodiment of the invention, there are two modes to handle a request for service:
The Inetd-mode: When a client connects the Inetd (Internet Daemon) process gets the request, and creates a new process to handle it (according to the associated port). Whenever another request arrives on the same port, the Internet daemon Inetd is the one to accept it (again), create the process, etc.

The Stand-alone-mode: The relevant process (HTTPD, for example) takes control over the relevant port and upon receiving a request for service, it is the one that answers and handles the request. Therefore, a port that is handled by a stand-alone process should never appear in the ports list handled by Inetd.

The reason that the HTTPD operates in stand-alone-mode and not managed by Inetd (although it could have been), is the overhead of creating a process. Hence, a Web site that gets hundreds of requests for HTTP service per second is getting better performance in the stand-alone-mode, since there is no need to initiate a process each call.

The Privileged Ports Problem

A well-known port refers herein to a protocol port that is widely used for a certain type of data on the network. For example, HTTP is typically assigned port 80, FTP transfer is port 20, the POP3 the port number 110, and X-Windows 6000. A Privileged port refers herein to a protocol port number from 0 through 1023.

On most systems, a privileged port can be used only by a system (root) process. However, due to security considerations, a VDS account should not be a root account, and hence cannot use privileged ports.

According to a preferred embodiment of the invention, in the Inetd-mode this conflict is solved by invoking another process that runs with root privileges and carries out the binding.

According to another preferred embodiment of the invention, in the Stand-alone-mode a different approach has to be implemented, as they should open the port themselves. One way to implement it is to replace the call to the relevant system call with another function that opens the port in a privileged mode, and hands it to the non-privileged process.

IP-Based VDS and Name-Based VDS

In the IP-based approach each VDS uses its own unique IP address. In the Name-based approach, some of the VDSes hosted by a computer system use a single IP address. Of course some of the VDSes hosted by one computer system may be IP-based and the other name-based.

Embodying the IP-Based VDS

Unix Socket is the mechanism with which a Unix-based system creates a connection to the outside world via a TCP/IP network. A socket is associated with an IP address and a port number.

According to one embodiment of the invention, HTTP service (such as the Apache process) is executed under the VDS restrictions, i.e. in non-root privileges. When it tries to retrieve incoming requests to port 80 (which is HTTP's well-known port number) of its IP, it uses a library call that checks that it is possible to “listen” on the requested port. If possible, it creates the port (in a privileged mode), and returns the socket for the process.

It should be noted that the privileges check is carried out only on opening the socket, and not on every operation, so the non-privileged Apache can use it. The fact that the check is carried out only when opening of the socket, and not on every read and write operation guarantees that this mechanism will not degrade the overall system performance.

For the FTP service there is a single process (Inetd) that waits for connection on all the relevant port numbers. When a request for connection arrives, it creates another process that “knows” to handle requests of this format (according to the port) and let this process handles the request. This process runs with root privileges, and therefore it can open the privileged sockets. Of course, this process is restricted by Chroot and Setuid, and thus resulting in a process that is limited to the specific VDS.

More particularly, there is one privileged process that “listens” on all the ports, which is usually the Inetd. In this case it is replaced by another process. When a connection is made, the process opens the socket, and handles it to a process that handles the relevant port's protocol. The recent process is not privileged, and therefore is restricted to the VDS directory tree.

Embodying the Name-Based VDS

This approach has been described in copending patent International Application No. PCT/IL02/00695.

Intercepting System Calls

Along with loading a program, the Unix operating system enables loading some libraries in the background. This library is called Shared Object in Unix (like DLL in Windows). A shared object also enables to override system calls, thus the system call is redirected to a function with the same name within a shared object. Hence, by the means of shared objects it is possible to intercept system calls.

In order to eliminate situations in which system calls and library functions invoked by one VDS could be revealed to running applications within other VDSes on the same computer, such calls and functions are intercepted by the system. By intermediating between the caller and the called function, both the input and output can be monitored and modified. In this way, an additional level of security is added to the VDS.

Interception of library (such as Libc or a compatible one) calls is carried out through inclusion of a “proxy” library within each “Chrooted” environment. Each function of the “proxy” library receives the designated parameters, and evaluates whether the real function should be executed. Should the real function be executed, the “proxy” function executes this function, possibly modifying the given parameters, and returns the result of the function to the calling application, possibly modifying the result. In the case that the real function should not be called, the proxy returns a result to the calling application by calculating it intrinsically.

By intercepting calls to Bind (the system utility that “binds” a port to a socket), the call to Bind can be redirected to another process.

The Kernel of the Hosting Operating System

The VDS technology enhances with more functionality some processes that are usually a part of the operating system environment, and enhances some system calls to be more focused. The technology, however, does not necessarily have to interfere with the kernel, and does not require any changes to the code of the kernel or recompiling the kernel (either by the WHP or by the product's company).

As Linux kernel can be built in various ways (using some modules as part of the process or not), forcing the WHP to use only a specific version of the kernel might not be acceptable.

Administrating a VDS

In order to simplify the administration of a domain, the Sysadmin (or the owner) of a domain is provided with an interface for managing the VDS from a remote station. This interface enables the Sysadmin to add e-mail accounts, modify existing ones, limit users' disk quota, etc. The interface saves time (and money) both for the domain owner (as he need not contact the hosting company with every request), and the hosting company, as their Sysadmins are not overwhelmed by a plethora of small requests.

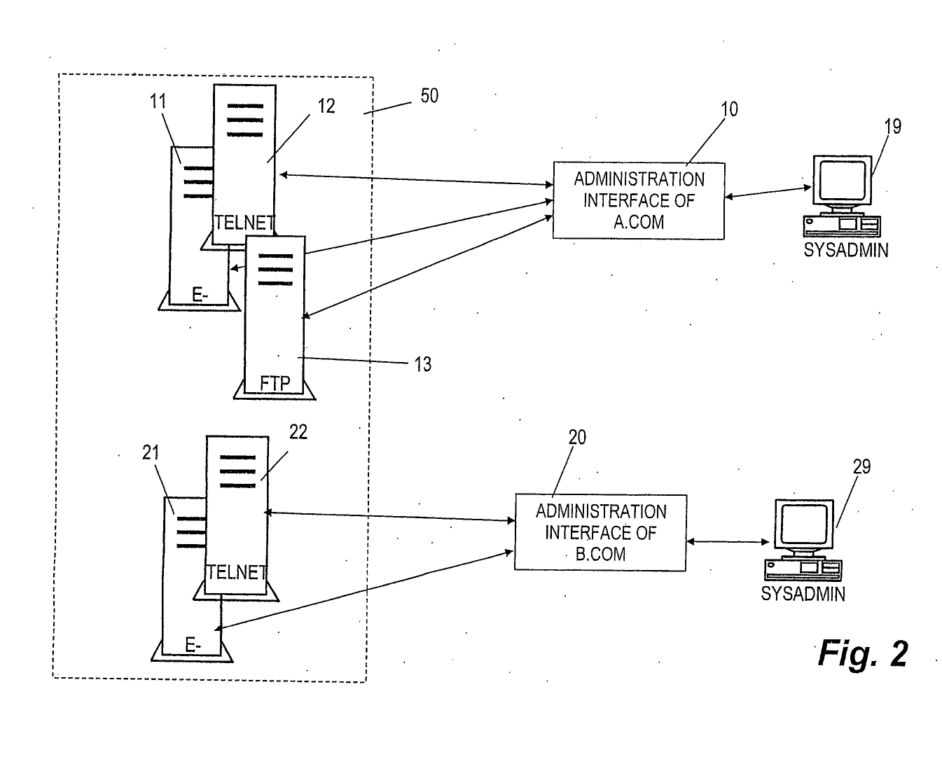

According to one embodiment of the invention, the Sysadmin downloads a Java-applet comprising the interface (marked as 10 and 20 in FIG. 2), preferably a GUI (Graphical User Interface), to his VDS, which provides secure access to his VDS. For example, by encoding/decoding between the user and the VDS, such that one of the keys is the user ID (usually referred as UID).

According to other embodiment of the invention, the GUI is a standard HTML interface, where the username and password are sent in a secured method (using SSL), and are verified on the server.

Actually, the GUI is a front-end to the management module. The advantage is the ability of the end-user to administrate his domain. The front-end can be Java applet or HTML.

The VDS owner can administrate his VDS by connecting to the machine that runs the VDS. The cluster manager can connect from any computer and manage the VDS.

According to one embodiment of the present invention, the administration functions are divided into administration levels. For example:
The VDS administration level, on which the Sysadmin administrates a single VDS;
The group administration level, on which the Sysadmin administrates a group of VDSes; and
The hosting computer administration level, on which the Sysadmin administrates all the VDSes hosted on a computer system.

As described in copending patent application No. PCT/IL02/00696, there is a higher administration level, the cluster, on which a group of computers hosting a plurality of VDSes is administrated by a Sysadmin.

FIG. 2 illustrates an administration diagram, according to a preferred embodiment of the invention. The domains a.com and b.com are hosted by the computer system 50. Sysadmin 19 administrates services 11 (e-mail), 12 (Telnet) and 13 (FTP) of domain a.com by interface 10. Sysadmin 29 administrates service 21 (e-mail) and Telnet 22 of domain b.com by interface 20.

The interface allows the Sysadmin to administrate the VDS from a remote station. Using the interface, the Sysadmin can add e-mail accounts, modify existing ones, limit users' disk quota, etc. The interface saves time (and costs) both for the domain owner (as he need not contact the hosting company with every request), and the hosting company, as their Sysadmins are not overwhelmed by a plethora of small requests.

Since the group administration level and the computer administration level are affecting a plurality of VDSes, the server of these modes operates in a root privileges, rather than the VDS administrator, which operates in non-root privileges.

According to one embodiment of the invention, the Sysadmin interacts with some component on the server side, which will be referred herein to as manager.cgi. The manager.cgi has the ability to transfer information to another process on the same computer, using a plug-in. The latter process is a privileged one, and it is the actual manager of the computer. Therefore, the user requests an operation from the Web-server component, (a CGI), that requests the managing process to perform the operation, and passes the user name and password as well. The managing process authenticates the user's identity, confirms that the request is legal for that user (i.e.—he is not trying to modify another VDS), and then the command is actually executed.

The following steps are carried out:

In order to use the administration facility, the Sysadmin browses a Web page on which he is asked to enter his user name and password. This Web page may reside on a Web site or on his computer.

This Web page executes the manager.cgi (which is the component that runs on the web server, accepts the request and calls the managing process using the plug-in). Typically, manager.cgi and the managing process reside on the hosting computer of the VDS.

QoS, Monitoring and SLA

Quality of Service (QoS) is the ability to define a level of performance in a data communications system, or in the performance of a system. QoS has become a major issue on the Internet and telephonic networks since voice and video signals should be displayed continuously. In a voice and/or video application, the packets arriving to a client should flow continuously, i.e. not fragmented.

One way to overcome this obstacle is displaying the video and/or voice signal with a lag. In this way, the data arriving to the client is accumulated, and displayed later. If the lag is minor, the viewer will not see the difference.

Voice and video applications in which one side broadcasts and the other one(s) listens are more lag-tolerant than applications wherein both sides transmit and receive signals.

In order to be able to provide a certain level of QoS for several instances of a service, the computer system that hosts the provider of this service should be much stronger than the total strength required for the QoS of all the instances together. If several VDSes are hosted by a computer system, the computer resources can be shared unequally between the hosted VDSes such that a VDS that requires more computer resources gets more resources than other VDSes.

Service License Agreement (SLA) is the commitment of the hosting computer owner to the VDS owner to provide certain amount of computer resources to the VDS, such as disk space, transmission bandwidth, memory, and so forth.

From the practical point of view, discriminately sharing the computer resource between the clients can be carried out by adding an entity intermediating between a resource and its clients, temporarily storing the requests, and sending the stored requests in a different order than according to arrival.

CPU usage and memory usage are an important issue for a Web site, as some processing power is needed for the site, in order to enable it to serve the site visitors in an adequate time, especially if some performance is promised to the Web site owner by an SLA.

The term Monitoring refers herein to measuring the usage of a computer resource at a given moment. For example, the amount of memory, disk space, CPU, bandwidth (in and out), the number of created processes, the number of connections to a database, etc.

Implementing the VDS Concept on Other Operating Systems

Although the examples presented herein are about the Unix-based operating system, the VDS concept can be implemented on other operating systems as well, e.g. Microsoft Windows NT.

The implementation of the VSD technology requires the following features of the operating system:

Hierarchical directory tree, since a VDS is associated with a directory tree.

Privileged access to a directory tree (Chroot).

Privileged access to specific files.

Privileged access to a specific process.

Supporting of accounts and the ability to restrict a user to his account.

A daemon that can “listen” to ports.

Hard links to system utilities and/or servers.

Intercepting of system calls.

In an operating system that these features are not supported, it is possible to add a virtual layer between the client and the operating system. The virtual layer simulates some or all the missing features. Those skilled in the art will appreciate that typically creating a virtual layer can be carried out by intercepting system calls.

Of course, the quality of the implementation under an operating system depends on the number of said features that is supported by the operating system.

Synopsis

The VDS's benefits:

Improved security, which is achieved due to the separation between the different sites hosted on the same computer.

Improved performance, which is achieved by running separated instances of service process for each VDS in the case of accessing to several Web sites simultaneously.

Improved resources exploitation, which is achieved by sharing a code segment of a service process between different virtual computers located on the same disk partition.

Improved administration, which is achieved through the fact that a less skilled person can carry out functions that only a skilled person could perform in the prior art.

These benefits are accomplished by:

Providing each VDS with its own virtual disk system (carried out by the Unix Chroot system call).

Intercepting a select group of system and library calls.

Using hard links between a template directory tree and particular virtual computer directory tree in order to save disk space.

Running all virtual computer processes under permission different from root and forwarding all management commands to the root privileged processes.

Performing authorization checks.

utilizing a single instance of the operating system

The VDS technology of the invention bridges the gap between shared server hosting and dedicated server hosting. It creates multiple virtual dedicated servers on a single computer system, with a single instance of the operating system. To the customer, such a virtual dedicated server is indistinguishable from a computer system. Both systems support the same applications and grant the customer the same administrative freedom. For all practical purposes, a VDS account differs from a dedicated server only by the amount of resources (disk space, 10 bandwidth, CPU power) that it possesses.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A method for hosting one or more virtual dedicated servers on a hosting computer system operating with a single instance of the operating system, each of which being an emulation of said hosting computer system on which accessing the system utilities and application programs is carried out remotely via a data network, comprising:
a) creating each virtual dedicated server, by:
(i) assigning a sub directory tree, derived from the root directory of said hosting computer file system, as the root directory tree of said virtual dedicated server;
(ii) placing a subset of the operating system utilities on the sub directory tree of said virtual dedicated server, as required by the services to be provided by said virtual dedicated server and by the operating system of said hosting computer in order to operate essentially in its regular operation mode; and
(iii) placing program(s) to be executed by said virtual dedicated server and/or hard links to said program(s) on said sub directory tree;
b) intercepting data incoming through the communication port(s) of said computer system; and
c) upon identifying in said data a request for service from a service provider associated with one of said virtual dedicated servers:
(i) identifying the virtual dedicated server to which said request is directed by processing said data;
(ii) if the provider of said service is not invoked yet on said virtual dedicated server, invoking the provider of said service stored in the corresponding sub directory tree of said virtual dedicated server;
(iii) forwarding said request to said service provider and provisioning said service by said service provider; and
(iv) optionally, upon terminating the provisioning of a request for service, terminating the process of said service provider.

2. The method according to claim 1, wherein some or all of the operating system utilities are replaced by corresponding hard links.

3. The method according to claim 1, wherein the sub directory tree is restricted by an account of said hosting computer.

4. The method according to claim 1, wherein one or more of the virtual dedicated servers is identified by their unique IP address.

5. The method according to claim 1, wherein one or more of the virtual dedicated servers is identified by one shared IP address and their name.

6. The method according to claim 1, wherein restricting a process being executed on a virtual dedicated server to its sub directory tree is carried out in a Unix-based operating system by the means of the Chroot system call or equivalent.

7. The method according to claim 6, wherein restricting a process being executed on a virtual dedicated server to its account is carried out in a Unix-based operating system by the means of the Setuid system directive or equivalent.

8. The method according to claim 1, wherein one, some or all of the VDSes hosted by the hosting computer system is administrated by one Sysadmin.

9. The method according to claim 1, wherein when implementing in a Unix-based system, no change of the kernel of the system is carried out.

10. The method according to claim 1, wherein the operating system calls regarding the utilization of the hosting computer's resources are intercepted for monitoring said computer's resources consumption.

11. The method according to claim 10, wherein the monitoring is used for obtaining the utilization rate of the virtual dedicated server(s), and/or for providing at least a predefined service level to said virtual dedicated servers, and/or for providing a minimum of Quality of Service to said virtual dedicated servers.

12. The method according to claim 1, wherein the hosting computer is a Unix-based system.

13. The method according to claim 1, wherein the service provider is an operating system service, or a program being executed on said virtual dedicated server.

14. The method according to claim 1, wherein the data network is a TCP/IP network.

15. The method according to claim 1, wherein file system and operating system services are shared by the VDSes.

16. A computer system for hosting one or more virtual dedicated servers, each of which being an emulation of the said computer system on which accessing the system utilities and application programs is carried out remotely via a data network, for each virtual dedicated server comprises:
a sub directory tree derived from the root directory of said computer's file system as the root directory tree of said virtual dedicated server;
a subset of the operating system utilities on the sub directory tree of said virtual dedicated server, as required by the services to be provided by said virtual dedicated server, according to the requirements of the operating system of said hosting computer in order to operate essentially in its regular operation mode;
software means for intercepting data passing through ports of the computer system and for directing said data to the appropriate virtual dedicated server; and
software means for analyzing said data and for identifying the virtual dedicated server to which said data is to be directed and for forwarding said data to said virtual dedicated server.

17. The computer system according to claim 16, wherein the computer is operating with a single instance of the operating system.

18. The computer system according to claim 16, wherein file system and operating system services are shared by the VDSes.

19. The computer system according to claim 16, wherein the sub directory tree is restricted by an account of the hosting computer.

20. The computer system according to claim 16, wherein one or more of the virtual dedicated servers are identified by their unique IP address.

21. The computer system according to claim 16, wherein one or more of the virtual dedicated servers are identified by one shared IP address and their name.

22. The computer system according to claim 16, wherein restricting a process being executed on a virtual dedicated server to its sub directory tree is carried out in a Unix-based operating system by the means of the Chroot system call or equivalent.

23. The computer system according to claim 19, wherein restricting a process being executed on a virtual dedicated server to its account is carried out in a Unix-based operating system by the means of the Setuid system directive or equivalent.

24. The computer system according to claim 16, wherein when implementing in a Unix-based system, no change of the kernel of the system is carried out.

25. The computer system according to claim 16, wherein the operating system calls regarding the utilization of the hosting computer's resources are intercepted for monitoring said computer's resources consumption.

26. The computer system according to claim 25, wherein the monitoring is used for obtaining the utilization rate of the virtual dedicated server(s), and/or for providing at least a predefined service level to said virtual dedicated servers, and/or for providing a minimum of Quality of Service to said virtual dedicated servers.

27. The computer system according to claim 16, wherein the hosting computer is a Unix-based system.

28. The computer system according to claim 16, wherein some or all of the operating system utilities are replaced by corresponding hard links.

29. The method for hosting one or more virtually dedicated servers, substantially as described and illustrated.
